(19) United States
(12) Patent Application Publication
(10) Pub. No.: US 2025/0385458 A1
(43) Pub. Date: Dec. 18, 2025

(54) PLUG-PIN STRUCTURE WITH INWARDLY-RETRACTED PLUG-IN POINTS

(71) Applicant: Dongguan Wontravel Electric Co.,Ltd, Dongguan (CN)

(72) Inventor: Liangguan LIN, Dongguan (CN)

(21) Appl. No.: 19/315,611

(22) Filed: Aug. 31, 2025

(30) Foreign Application Priority Data
Apr. 30, 2025 (CN) 202520856920.7

(51) Int. Cl. H01R 13/35; H01R 13/502; H01R 31/06; H01R 103/00

(52) U.S. Cl. CPC H01R 13/35; H01R 13/502; H01R 31/06; H01R 2103/00

(57) ABSTRACT

A plug-pin structure with inwardly-retracted plug-in points, including a frame provided inside an adapter and a plug-pin unit slidably connected to the frame. The plug-pin unit includes at least three plug-pin assemblies arranged side by side, including a first plug-pin assembly, a second plug-pin assembly and a third plug-pin assembly. The frame includes a base plate. The frame is provided with two conductive metal components respectively corresponding to a live (L) pole and a neutral (N) pole. Each of the first plug-pin assembly, the second plug-pin assembly and the third plug-pin assembly includes a sliding part, a plug pin and a plug-in part. Each conductive metal component is provided with a plug-in point configured to engage with the plug-in part. The plug-in points are located within orthographic projections of two sliding parts located at two ends of the plug-pin unit toward the base plate.

### CROSS-REFERENCE TO RELATED APPLICATIONS

This application claims the benefit of priority from Chinese Patent Application No. 202520856920.7, filed on Apr. 30, 2025. The content of the aforementioned application, including any intervening amendments made thereto, is incorporated herein by reference in its entirety.

### TECHNICAL FIELD

This application relates to adapters, and more particularly to a plug-pin structure with inwardly-retracted plug-in points.

### BACKGROUND

International travel or business trip has become increasingly popularized. Many types of electrical plugs have been designed to respectively adapt to different power outlets in different countries. Generally, the domestic electrical devices cannot be compatible with foreign sockets, causing significant inconvenience.

Therefore, to make travel more convenient, an adapter has appeared on the market that is provided with different types of plug-pin assemblies adapted for use in different regions. As people tend to carry many items during travel, there is a need for the size of such adapters to be as compact and portable as possible. In some existing adapters, two sets of metal components connected by a fuse and a conductive member are provided for power conduction. A first set of the two sets of metal components corresponds to receptacles of the adapter, and is configured for electrical connection with an electrical product plugged into the adapter. A second set of the two sets of metal components is provided opposite to the first set of the two sets of metal components, and is configured for mutual insertion between components on a plug pin after the plug pin extends out of the adapter. When the plug pin is inserted into an external socket, the second set of the two sets of metal components is energized, and the first set of the two sets of metal components is also energized through the fuse and the conductive member. Currently, since the plug-pin assemblies are configured with a plurality of sets of different specifications, the second set of the two sets of metal components is provided with a plurality of plug-in points. The plurality of plug-in points are located on an outer side of the second set of the two sets of metal components. This arrangement causes the second set of the two sets of metal components to be relatively large in size. Likewise, the plurality of sets of plug-pin assemblies of different specifications are each provided with a connecting component matching the plug-in points. The connecting component is configured to extend out of each plug-pin assembly. As a result, a housing of the adapter must be made large enough to accommodate the above components, which leads to a relatively large overall size of the adapter.

Therefore, there is an urgent need for a plug-pin structure with inwardly-retracted plug-in points to address the above-mentioned technical problems.

### SUMMARY

An object of the disclosure is to provide a plug-pin structure with inwardly-retracted plug-in points to overcome the defects in the prior art.

Technical solutions of the present disclosure are described as follows.

A plug-pin structure with inwardly-retracted plug-in points, comprising:
a frame; and
a plug-pin unit;
wherein the frame is provided inside an adapter;
the plug-pin unit is slidably connected to the frame;
the plug-pin unit is configured to slide along the frame, and extend from the frame for insertion into an external socket;
the plug-pin unit comprises at least three plug-pin assemblies arranged side by side, comprising a first plug-pin assembly, a second plug-pin assembly and a third plug-pin assembly;
the frame comprises a base plate; the base plate is provided with a plurality of aperture configured to allow the plug-pin unit to extend through and a plurality of guide posts arranged vertically; and the frame is provided with two conductive metal components respectively corresponding to a live (L) pole and a neutral (N) pole;
the first plug-pin assembly, the second plug-pin assembly and the third plug-pin assembly each comprises a sliding part, a plug pin and a plug-in part;
the sliding part is slidably connected to the plurality of guide posts;
a first end of the plug pin is provided on the sliding part, and a second end of the plug pin is configured to extend toward the base plate;
a first end of the plug-in part is fixed to the sliding part and electrically connected to the plug pin, and a second end of the plug-in part is configured to extend downward;
each of the two conductive metal components is provided with a plug-in point configured to engage with the plug-in part; and
the plug-in points are located within orthographic projections of two sliding parts located at two ends of the plug-pin unit toward the base plate.

In some embodiments, the two conductive metal components are located within orthographic projections of the first plug-pin assembly and the second plug-pin assembly toward the base plate.

In some embodiments, the sliding part of the first plug-pin assembly comprises two mounting portions arranged side by side;
an avoidance space is defined between the two mounting portions;
a connecting portion for connecting the two mounting portions is provided between the two mounting portions;
the first plug-pin assembly is provided with a three-pole plug pin corresponding respectively to an earth (E) pole, the L pole and the N pole;
the three-pole plug pin is mounted on the two mounting portions;
the plug-in part of the first plug-pin assembly is provided on one of the two mounting portions, and comprises an extending portion extending toward the other of the two mounting portions;
an end of the extending portion is provided with a bending portion bending downward, and the bending portion is configured to engage with the plug-in point; and
an orthographic projection of the bending portion toward the base plate is located within an orthographic projection of the mounting portion toward the base plate or within the avoidance space.

In some embodiments, the sliding part of the second plug-pin assembly comprises a telescopic portion and a linkage portion arranged side by side in a vertical direction and slidably connected to the frame;
the plug pin of the second plug-pin assembly for insertion into the external socket is provided on the telescopic portion;
the linkage portion is provided with a through hole configured to allow the plug pin to extend or retract;
the plug-in part of the second plug-pin assembly is provided on the telescopic portion; the number of the plug-in part of the second plug-pin assembly is two; and
one of two plug-in parts of the second plug-pin assembly is provided on a side of the telescopic portion facing the second plug-pin assembly, and the other of the two plug-in parts of the second plug-pin assembly is provided on a side of the telescopic portion facing the first plug-pin assembly or on a side adjacent to the side of the telescopic portion facing the first plug-pin assembly.

In some embodiments, a plug pin of the three-pole plug pin of the first plug-pin assembly corresponding to the E pole is provided adjacent to the linkage portion of the second plug-pin assembly.

In some embodiments, the number of the bending portion is two; two bending portions have a flat shape, and a length direction of each of the two bending portions is parallel to a length direction of each of the two mounting portions; and
the plug-in point corresponding to each of the two bending portions is provided with a plug-in port in a flat shape.

In some embodiments, the third plug-pin assembly is provided within the avoidance space.

In some embodiments, the frame is further provided with a partition plate, and the partition plate is provided on an outer side of the first plug-pin assembly, and is configured to separate the plug-pin unit from an exterior of the frame.

Compared to the prior art, the present disclosure has the following beneficial effects.

Regarding the plug-pin structure with inwardly-retracted plug-in points provided herein, the plug-in point on each of the two conductive metal components is retracted inward, and the plug-in parts of the plug-pin assemblies corresponding the plug-in points are provided on inner sides of the plug-pin assemblies (sides of the plug-pin assemblies oriented toward an inner side of the frame). This arrangement reduces an overall volume of the conductive metal components and the plug-pin assemblies, prevents the plug-in parts from outwardly protruding from the plug-pin assemblies and increasing its size, thereby effectively reducing an overall size of an adapter and enabling the adapter to be miniaturized and made portable.

During operation, the plug-in points are configured to be plugged into the plug-in parts on the plug-pin assemblies after the plug-pin assemblies slides along the frame and extends from the frame, thereby establishing electrical connection between the plug-pin assemblies and the conductive metal components. When the plug pins are inserted into the external socket, the conductive metal components are energized. At this time, the plug-in points provided on the conductive metal components are located between the first plug-pin assembly and the second plug-pin assembly, and fall within orthographic projections of two sliding parts of the first plug-pin assembly and the second plug-pin assembly toward the base plate. In other words, the distribution of the plug-in points does not exceed an outer contour of the plug-pin unit. Accordingly, each plug-in part provided on each of the first, second and third plug-pin assemblies is also located within the orthographic projection of the plug-pin unit toward the base plate, thereby preventing the plug-in points and plug-in parts from extending outward. By arranging the plug-in points in an inwardly-retracted manner, the sizes of the conductive metal components, the base plate, and the plug-pin unit can be reduced, which further decreases the overall size of the adapter and enables its miniaturization and portability.

### BRIEF DESCRIPTION OF THE DRAWINGS

FIG. 1 is a structural diagram of a plug-pin structure with inwardly-retracted plug-in points according to an embodiment of the present disclosure;

FIG. 2 is a structural diagram of a frame after an upper part is removed according to an embodiment of the present disclosure;

FIG. 3 is a structural diagram of a first plug-pin assembly after extending out of the frame according to an embodiment of the present disclosure;

FIG. 4 is an exploded view of the plug-pin structure with inwardly-retracted plug-in points according to an embodiment of the present disclosure;

FIG. 5 is a structural diagram of the frame according to an embodiment of the present disclosure;

FIG. 6 is a structural diagram of the first plug-pin assembly assembled with the frame according to an embodiment of the present disclosure;

FIG. 7 is a structural diagram of the first plug-pin assembly according to an embodiment of the present disclosure;

FIG. 8 is a structural diagram of a second plug-pin assembly assembled with the frame according to an embodiment of the present disclosure;

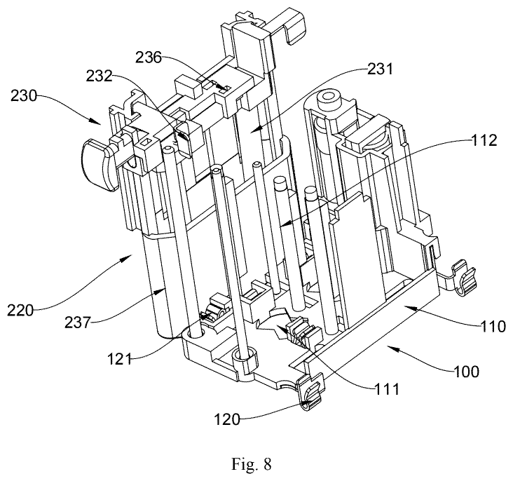

FIG. 9 is a structural diagram of a third plug-pin assembly assembled with the frame according to an embodiment of the present disclosure; and

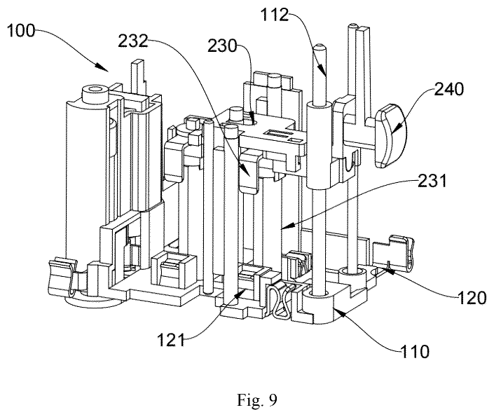

FIG. 10 is a structural diagram of the plug-pin structure with inwardly-retracted plug-in points according to an embodiment of the present disclosure provided with a partition plate.

In the figures: 100—frame; 200—plug-pin unit; 210—first plug-pin assembly; 220—second plug-pin assembly; 110—base plate; 111—aperture; 112—guide post; 120—conductive metal component; 230—sliding part; 231—plug pin; 232—plug-in part; 121—plug-in point; 233—mounting portion; 234—avoidance space; 235—connecting portion; 2321—extending portion; 2322—bending portion; 236—telescopic portion; 237—linkage portion; 1211—plug-in port; 240—third plug—pin assembly; and 101—partition plate.

### DETAILED DESCRIPTION OF EMBODIMENTS

In order to facilitate the understanding of technical solutions of the present disclosure, the present disclosure will be further described in conjunction with the embodiments and the accompanying drawings. It should be noted that the embodiments are merely exemplary, and are not intended to limit the present disclosure. A detailed description of the present disclosure will be provided below in conjunction with the accompanying drawings.

An embodiment of the present disclosure provides a plug-pin structure with inwardly-retracted plug-in points, in which plug-in points 121 on conductive metal components 120 are retracted inward, and plug-in parts 232 of plug-pin assemblies corresponding the plug-in points 121 are provided on inner sides of the plug-pin assemblies (sides of the plug-pin assemblies oriented toward an inner side of the frame). This arrangement reduces an overall volume of the conductive metal components 120 and the plug-pin assemblies, prevents the plug-in parts 232 from outwardly protruding from the plug-pin assemblies and increasing its size, thereby effectively reducing an overall size of an adapter and enabling the adapter to be miniaturized and made portable.

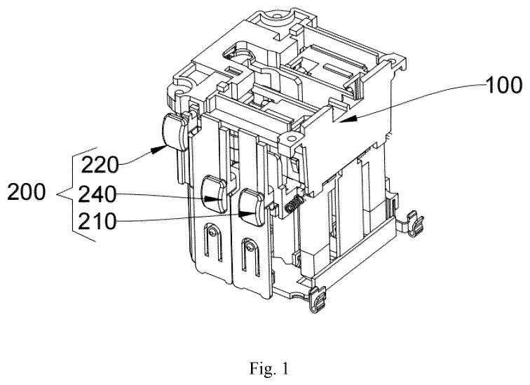

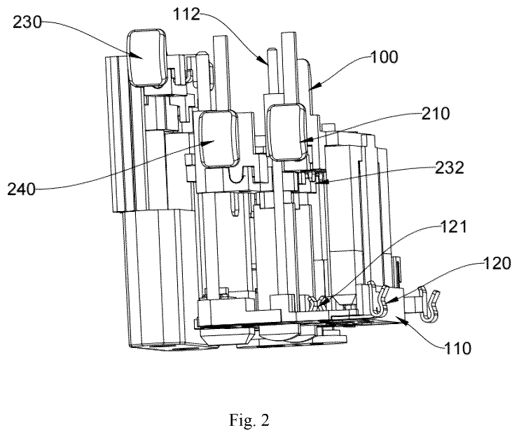

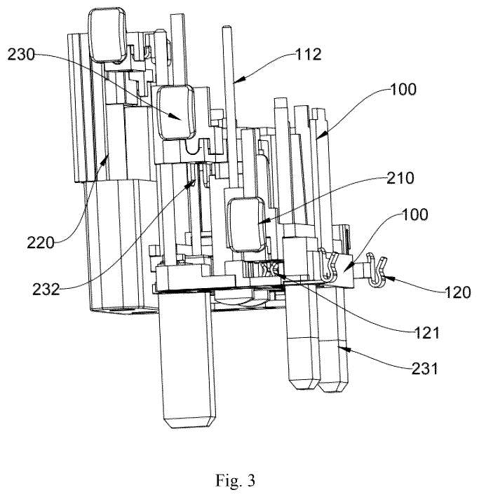

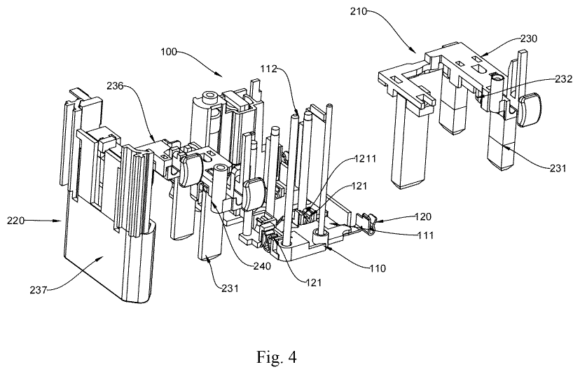

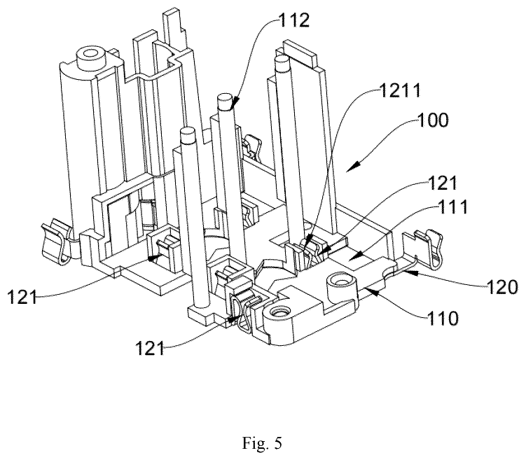

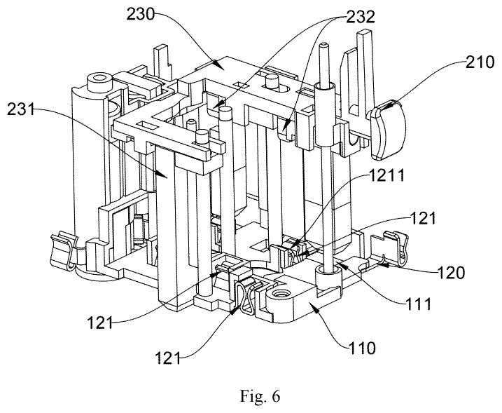

Specifically, as shown in FIGS. 1-6, the present embodiment provides a plug-pin structure with inwardly-retracted plug-in points, including a frame 100 and a plug-pin unit 200. The frame 100 is provided inside an adapter. The plug-pin unit 200 is slidably connected to the frame 100. The plug-pin unit 200 is configured to slide along the frame 100, and extend from the frame 100 for insertion into an external socket. The plug-pin unit 200 includes at least three plug-pin assemblies arranged side by side, including a first plug-pin assembly 210, a second plug-pin assembly 220 and a third plug-pin assembly 240. The frame 100 includes a base plate 110. The base plate 110 is provided with a plurality of aperture 111 configured to allow the plug-pin unit 200 to extend through and a plurality of guide posts 112 arranged vertically. The frame 100 is provided with two conductive metal components 120 respectively corresponding to a live (L) pole and a neutral (N) pole. Meanwhile, the first plug-pin assembly 210, the second plug-pin assembly 220 and the third plug-pin assembly 240 each include a sliding part 230, a plug pin 231 and a plug-in part 232. Specifically, the sliding part 230 is slidably connected to the plurality of guide posts 112. A first end of the plug pin 231 is provided on the sliding part 230, and a second end of the plug pin 231 is configured to extend toward the base plate 110. A first end of the plug-in part 232 is fixed to the sliding part 230 and electrically connected to the plug pin 231, and a second end of the plug-in part 232 is configured to extend downward. Each of the conductive metal components 120 is provided with a plug-in point 121 configured to engage with the plug-in part 232. The plug-in points 121 are located within orthographic projections of two sliding parts 230 positioned at two ends of the plug-pin unit 200 toward the base plate 110.

During operation, the plug-in points 121 are configured to be plugged into the plug-in parts 232 on the plug-pin assemblies after the plug-pin assemblies slides along the frame and extends from the frame 100, thereby establishing electrical connection between the plug-pin assemblies and the conductive metal components 120. When the plug pins 231 are inserted into the external socket, the conductive metal components 120 are energized. At this time, the plug-in points 121 provided on the conductive metal components are located between the first plug-pin assembly 210 and the second plug-pin assembly 220, and fall within orthographic projections of two sliding parts of the first plug-pin assembly 210 and the second plug-pin assembly 220 toward the base plate 110. In other words, the distribution of the plug-in points 121 does not exceed an outer contour of the plug-pin unit 200. Accordingly, each plug-in part 232 provided on each of the first plug-pin assembly 210, the second plug-pin assembly 220 and the third plug-pin assembly 240 is also located within the orthographic projection of the plug-pin unit 200 toward the base plate 110, thereby preventing the plug-in points 121 and plug-in parts 232 from extending outward. By arranging the plug-in points 121 in an inwardly-retracted manner, the sizes of the conductive metal components 120, the base plate 110, and the plug-pin unit 200 can be reduced, which further decreases the overall size of the adapter and enables its miniaturization and portability.

In this embodiment, the two conductive metal components 120 are located within orthographic projections of the first plug-pin assembly 210 and the second plug-pin assembly 220 toward the base plate 110. More specifically, the two conductive metal components 120 respectively corresponding to a neutral wire and a live wire are provided within orthographic projections of the sliding parts 230 on the first plug-pin assembly 210 and the second plug-pin assembly 220 toward the base plate 110, thereby further reducing the overall size of the conductive metal components 120.

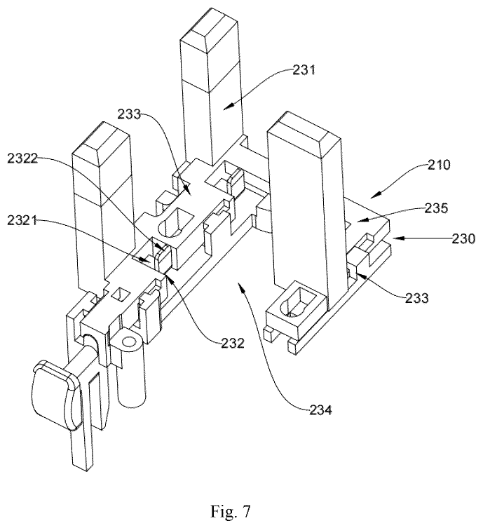

FIG. 7 is a structural diagram of the first plug-pin assembly 210. The sliding part 230 of the first plug-pin assembly 210 includes two mounting portions 233 arranged side by side. An avoidance space 234 is defined between the two mounting portions 233. A connecting portion 235 for connecting the two mounting portions is provided between the two mounting portions 233. The first plug-pin assembly 210 is provided with a three-pole plug pin corresponding to an earth (E) pole, the L pole and the N pole, respectively. The three-pole plug pin is mounted on the two mounting portions 233. The plug-in part 232 of the first plug-pin assembly 210 is provided on one of the mounting portions 233, and includes an extending portion 2321 extending toward the other of the mounting portions 233. An end of the extending portion 2321 is provided with a bending portion 2322 bending downward. The bending portion 2322 is configured to engage with the plug-in point 121. An orthographic projection of the bending portion 2322 toward the base plate 110 is located within an orthographic projection of the mounting portion 233 toward the base plate 110 or within the avoidance space 234.

In this embodiment, the third plug-in assembly is provided between the first plug-in assembly and the second plug-in assembly. More specifically, the third plug-pin assembly 240 is arranged within the avoidance space 234, thereby reducing the spacing between the first plug-pin assembly 210, the second plug-pin assembly 220, and the third plug-pin assembly 240, and thus reducing a width of the plug-pin unit 200.

A plug pin of the three-pole plug pin the first plug-pin assembly 210 corresponding to a ground wire is provided on one of the mounting portions 233, and the remaining two plug pins of the three-pole plug pin the first plug-pin assembly 210 corresponding to the live wire and the neutral wire are provided on the other of the mounting portions 233, such that the three plug-pins are arranged in a triangular configuration. The plug-in part 232 for insertion into the plug-in point 121 is provided on the mounting portion 233 having the two plug pins 231, thereby facilitating connection with the plug-in point 121. The plug-in part 232 of the first plug-pin assembly 210 is formed with two parts, where the extending portion 2321 is configured to extend toward the other of the mounting portions 233, such that the plug-in part 232 of the first plug-pin assembly 210 is maintained within the orthographic projection of the first plug-pin assembly 210 toward the base plate 110. Through the above arrangement, the direction and position of the plug-in part 232 are reasonably configured to reduce the size of the first plug-pin assembly 210, thereby contributing to miniaturization and portability of the adapter.

In this embodiment, the second plug-pin assembly 220 is configured as an EU-standard plug-pin 231. That is, the sliding part 230 of the second plug-pin assembly 220 includes a telescopic portion 236 and a linkage portion 237, which are arranged side by side in a vertical direction and slidably connected to the frame 100. The plug pin 231 of the second plug-pin assembly 220 for insertion into the external socket is provided on the telescopic portion 236. The linkage portion 237 is provided with a through hole to allow the plug pin 231 to extend or retract. The plug-in part 232 of the second plug-pin assembly 220 is provided on the telescopic portion 236. The number of the plug-in part 232 of the second plug-pin assembly 220 is two. One of two plug-in parts 232 of the second plug-pin assembly 220 is provided on a side of the telescopic portion 236 facing the second plug-pin assembly 220, and the other of the two plug-in parts 232 of the second plug-pin assembly 220 is provided on a side of the telescopic portion 236 facing the first plug-pin assembly 210 or on a side adjacent to the side of the telescopic portion 236 facing the first plug-pin assembly 210.

In this embodiment, one of two plug-in parts 232 of the second plug-pin assembly 220 is oriented toward the first plug-pin assembly 210, and the other of the two plug-in parts 232 of the second plug-pin assembly 220 is provided on a side of the sliding part 230 in a length direction of the sliding part 230. This arrangement prevents the plug-in parts 232 from extending in a direction away from the plug-pin unit 200, thereby maintaining the overall size of the plug-pin unit 200.

In this embodiment, a plug pin 231 of the three-pole plug pin of the first plug-pin assembly 210 corresponding to the E pole is provided adjacent to the linkage portion 237 of the second plug-pin assembly 220. That is, during sliding movement of the first plug-pin assembly 210 or the second plug-pin assembly 220 along the guide posts 112, the tight contact between the plug pin 231 corresponding to the E pole and the linkage portion 237 enables mutual positioning, thereby ensuring stability during the sliding process.

In this embodiment, the number of the bending portion 2322 is two. Two bending portions 2322 have a flat shape, and a length direction of each bending portion 2322 is parallel to a length direction of each mounting portion 233. The plug-in point 121 corresponding to each bending portion 2322 is provided with a plug-in port 1211 in a flat shape. By arranging each of the bending portions 2322 parallel to the length direction of the mounting portion 233, the bending portions 2322 form a flat structure, which reduces the width of the bending portions 2322 and enables a more compact width of the first plug-pin assembly 210, thereby further reducing the size of the plug-pin unit 200. Meanwhile, the bending portions 2322 and the plug-in port 1211 provided on the plug-in point 121 are configured in a flat shape, ensures a larger contact area during the engagement between the plug-in parts 232 and the plug-in points 121, thereby improving the stability of the electrical connection.

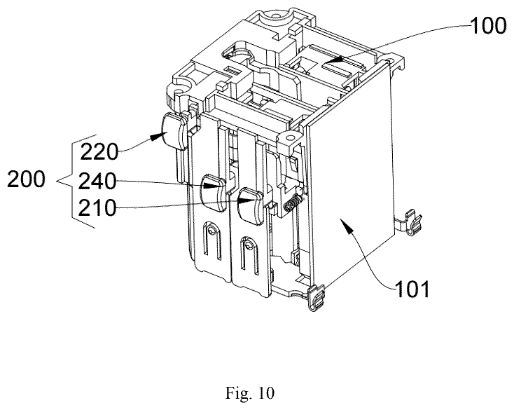

As shown in FIG. 10, in this embodiment, the frame 100 is further provided with a partition plate 101. The partition plate 101 is located on an outer side of the first plug-pin assembly 210, and is configured to separate the plug-pin unit 200 from an exterior of the frame 100. After the plug-pin structure with inwardly-retracted plug-in points is installed within a housing of the adapter, the frame 100 is configured to space the frame 100 and the plug-pin assembly apart through the partition plate 101, thereby creating a reserved space within the housing. In some embodiments, to enhance the functionality of the adapter, a direct current (DC) output assembly, a wireless charging module or other components can be provided in the reserved space, thereby expanding the capabilities of the adapter.

Described above are merely preferred embodiments of the present disclosure, and are not intended to limit the scope of the present disclosure. Any equivalent structural changes made based on the description and the accompanying drawings of the present disclosure under the inventive concept of the present disclosure, or direct/indirect application in other related technical fields shall fall within the scope of the present disclosure defined by the appended claims.

What is claimed is:

1. A plug-pin structure with inwardly-retracted plug-in points, comprising:
a frame; and
a plug-pin unit;
wherein the frame is provided inside an adapter;
the plug-pin unit is slidably connected to the frame;
the plug-pin unit is configured to slide along the frame, and extend from the frame for insertion into an external socket;
the plug-pin unit comprises at least three plug-pin assemblies arranged side by side, comprising a first plug-pin assembly, a second plug-pin assembly and a third plug-pin assembly;
the frame comprises a base plate; the base plate is provided with an aperture configured to allow the plug-pin unit to extend through and a plurality of guide posts arranged vertically; and the frame is provided with two conductive metal components respectively corresponding to a live (L) pole and a neutral (N) pole;
the first plug-pin assembly, the second plug-pin assembly and the third plug-pin assembly each comprises a sliding part, a plug pin and a plug-in part;
the sliding part is slidably connected to the plurality of guide posts;
a first end of the plug pin is provided on the sliding part, and a second end of the plug pin is configured to extend toward the base plate;
a first end of the plug-in part is fixed to the sliding part and electrically connected to the plug pin, and a second end of the plug-in part is configured to extend downward;
each of the two conductive metal components is provided with a plug-in point configured to engage with the plug-in part; and
the plug-in points are located within orthographic projections of two sliding parts located at two ends of the plug-pin unit toward the base plate.

2. The plug-pin structure with inwardly-retracted plug-in points according to claim 1, wherein the two conductive metal components are located within orthographic projections of the first plug-pin assembly and the second plug-pin assembly toward the base plate.

3. The plug-pin structure with inwardly-retracted plug-in points according to claim 1, wherein the sliding part of the first plug-pin assembly comprises two mounting portions arranged side by side;
an avoidance space is defined between the two mounting portions;
a connecting portion for connecting the two mounting portions is provided between the two mounting portions;
the first plug-pin assembly is provided with a three-pole plug pin corresponding respectively to an earth (E) pole, the L pole and the N pole;
the three-pole plug pin is mounted on the two mounting portions;
the plug-in part of the first plug-pin assembly is provided on one of the two mounting portions, and comprises an extending portion extending toward the other of the two mounting portions;
an end of the extending portion is provided with a bending portion bending downward, and the bending portion is configured to engage with the plug-in point; and
an orthographic projection of the bending portion toward the base plate is located within an orthographic projection of the mounting portion toward the base plate or within the avoidance space.

4. The plug-pin structure with inwardly-retracted plug-in points according to claim 3, wherein the sliding part of the second plug-pin assembly comprises a telescopic portion and a linkage portion arranged side by side in a vertical direction and slidably connected to the frame;
the plug pin of the second plug-pin assembly for insertion into the external socket is provided on the telescopic portion;
the linkage portion is provided with a through hole configured to allow the plug pin to extend or retract;
the plug-in part of the second plug-pin assembly is provided on the telescopic portion; the number of the plug-in part of the second plug-pin assembly is two; and
one of two plug-in parts of the second plug-pin assembly is provided on a side of the telescopic portion facing the second plug-pin assembly, and the other of the two plug-in parts of the second plug-pin assembly is provided on a side of the telescopic portion facing the first plug-pin assembly or on a side adjacent to the side of the telescopic portion facing the first plug-pin assembly.

5. The plug-pin structure with inwardly-retracted plug-in points according to claim 4, wherein a plug pin of the three-pole plug pin of the first plug-pin assembly corresponding to the E pole is provided adjacent to the linkage portion of the second plug-pin assembly.

6. The plug-pin structure with inwardly-retracted plug-in points according to claim 3, wherein the number of the bending portion is two; two bending portions have a flat shape, and a length direction of each of the two bending portions is parallel to a length direction of each of the two mounting portions; and
the plug-in point corresponding to each of the two bending portions is provided with a plug-in port in a flat shape.

7. The plug-pin structure with inwardly-retracted plug-in points according to claim 3, wherein the third plug-pin assembly is provided within the avoidance space.

8. The plug-pin structure with inwardly-retracted plug-in points according to claim 1, wherein the frame is further provided with a partition plate, and the partition plate is provided on an outer side of the first plug-pin assembly, and is configured to separate the plug-pin unit from an exterior of the frame.
